(19) United States
(12) Patent Application Publication
(10) Pub. No.: US 2014/0332194 A1
(43) Pub. Date: Nov. 13, 2014

(54) APPARATUS, SYSTEMS AND METHODS FOR REDUCING NOISE GENERATED BY ROTATING COUPLINGS AND DRIVES

(71) Applicant: MagnaDrive Corporation, Woodinville, WA (US)

(72) Inventors: Dan Durland, Seattle, WA (US); Mike Tomczak, Stanwood, WA (US); Jeongkwan Lee, Houston, TX (US); Dennis Noson, Seattle, WA (US)

(73) Assignee: MagnaDrive Corporation, Woodinville, WA (US)

(21) Appl. No.: 14/180,071

(22) Filed: Feb. 13, 2014

Related U.S. Application Data
(60) Provisional application No. 61/820,606, filed on May 7, 2013.

(51) Int. Cl. H02K 5/24; H02K 15/02; H02K 49/00

(52) U.S. Cl. CPC H02K 5/24; H02K 49/00; H02K 15/02
USPC 165/185; 29/598

(57) ABSTRACT

A heat sink element for a device is operable by relative rotation of a conductor rotor assembly and a magnet rotor assembly. The heat sink element includes a base portion and a plurality of fins. The base portion includes a mounting face that is sized and dimensioned to be coupled to the conductor rotor assembly, and an opposing convective heat transfer face. The plurality of fins extend from the convective heat transfer face of the base portion. Adjacent fins are separated by a channel that extends along a longitudinal direction of the fins. The fins include at least one surface disruption on a top surface thereof.

### BACKGROUND

1. Technical Field

The present disclosure relates to heat sink assemblies and associated retrofit methods for various air cooled mechanisms, including, but not limited to adjustable speed magnetic drive systems, fixed gap magnetic couplings, and magnetic couplings and drives that include speed trimming, torque limiting, and delayed start features.

2. Description of the Related Art

Adjustable speed magnetic drive systems operate by transmitting torque from a motor to a load across an air gap. There is no mechanical connection between the driving and driven sides of the equipment. Torque is created by the interaction of powerful rare-earth magnets on one side of the drive with induced magnetic fields on the other side. By varying the air gap spacing, the amount of torque transmitted can be controlled, thus permitting speed control.

Conventionally, adjustable speed drives of this type consist of three sets of components. A magnet rotor assembly, containing rare-earth magnets, is attached to the load. A conductor rotor assembly is attached to the motor. The conductor rotor assembly includes a rotor made of a conductive material, such as aluminum, copper, or brass. Actuation components control the air gap spacing between the magnet rotors and the conductor rotors. Relative rotation of the conductor and magnet rotor assemblies induces a powerful magnetic coupling across the air gap. Varying the air gap spacing between the magnet rotors and the conductor rotors results in controlled output speed. The output speed is adjustable, controllable, and repeatable.

The principle of magnetic induction requires relative motion between the magnets and the conductors. This means that the output speed is always less than the input speed. The difference in speed is known as slip. Typically, slip during operation at a full rating motor speed is between 1% and 3%.

The relative motion of the magnets in relation to the conductor rotor causes eddy currents to be induced in the conductor material. The eddy currents in turn create their own magnetic fields. It is the interaction of the permanent magnet fields with the induced eddy current magnetic fields that allow torque to be transferred from the magnet rotor to the conductor rotor. The electrical eddy currents in the conductor material create electrical heating in the conductor material.

Conventionally, fins are arranged on an external surface of the conductor rotors to aid in the removal of heat during operation of the drive unit. FIGS. 1 and 2 illustrate one such conventional configuration. An adjustable speed drive 10 includes conductor rotors 12 and 14 coupled together by spacers 16. A plurality of heat transfer elements 20 are circumferentially arrayed on an external surface of the conductor rotors 12 and 14. As shown in FIGS. 2A-2C, each heat transfer element 20 includes a plurality of fins 26 that extend from a base 22 to define a plurality of channels 28 between the fins 26. The heat transfer elements 20 can be secured to the conductor rotors 12 and 14 via openings 24 in the base 22. The heat transfer elements 20 are coupled to the conductor rotors 12 and 14 such that the fins 26 and channels 28 extend in a substantially radial direction relative to an axis of rotation of the conductor rotors 12 and 14. As the adjustable speed drive is operated, the rotation of the rotors 12 and 14 causes air to flow radially outward through the channels 28, thereby cooling the conductor rotors 12 and 14.

### BRIEF SUMMARY

It has been observed that the inclusion of heat sink assemblies on the conductor rotors of an adjustable speed drive generate an unacceptable amount of noise during operation. It has been further observed that by disrupting the edge geometry on fins of the heat sinks, sound levels can be reduced to acceptable ranges for both low and high speed operation of the adjustable speed drive without compromising the heat transfer benefits of the heat sinks.

A heat sink element for a device operable by relative rotation of a conductor rotor assembly and a magnet rotor assembly includes a base portion and a plurality of fins. The base portion includes a mounting face that is sized and dimensioned to be coupled to the conductor rotor assembly, and an opposing convective heat transfer face. The plurality of fins extend from the convective heat transfer face of the base portion. Adjacent fins are separated by a channel that extends along a longitudinal direction of the fins. The fins include at least one surface disruption on a top surface thereof. The surface disruption can be a notch. The surface disruption can be a triangle. The surface disruption can be a scalloped surface. The surface disruption can be a continuous curve.

An rotary unit includes a magnet rotor assembly and a conductor rotor assembly positioned relative to the magnet rotor assembly such that there is an air gap between the magnet rotor assembly and the conductor rotor assembly, and such that relative rotation of the conductor and magnet rotor assemblies induces a magnetic coupling across the air gap. A heat sink assembly is coupled to the conductor assembly. The heat sink assembly includes a plurality of fins. Adjacent fins are separated by a channel that extends along a longitudinal direction of the fins. The fins include at least one surface disruption on a top surface thereof. The heat sink assembly can include a plurality of heat sink elements that are arranged on an external surface of the conductor rotor assembly, each heat sink element including the plurality of groupings of fins. On at least one of the heat sink assemblies, the surface disruption can be a notch. On the at least one of the heat sink assemblies, the surface disruption can be a triangle. On the at least one of the heat sink assemblies, the surface disruption can be a scalloped surface. On the at least one of the heat sink assemblies, the surface disruption can be a continuous curve.

A method of reducing noise generated by a rotary member that is operable by relative rotation of a conductor rotor assembly and a magnet rotor assembly includes removing a first heat sink element from the conductor rotor assembly, the first heat sink element including a first plurality of fins that extend in a substantially radial direction relative to an axis of rotation of the conductor rotor assembly; and then coupling a second heat sink element to the conductor rotor assembly in place of the first heat sink element, the second heat sink element including a second plurality of fins that extend in a substantially radial direction relative to the axis of rotation of the conductor rotor assembly, the exposed surface area of the second plurality of fins including a surface disruption profile. The surface disruption profile can include a plurality of notches. The surface disruption profile can include a plurality of triangles. The surface disruption profile can include scalloping. The surface disruption profile can include a continuous curve.

### BRIEF DESCRIPTION OF THE SEVERAL VIEWS OF THE DRAWINGS

In the drawings, identical reference numbers identify similar elements or acts.

FIG. 1A is an isometric view of a conventional heat sink arrangement on an adjustable speed drive.

FIG. 1B is a front view of the adjustable speed drive of FIG. 1A.

FIG. 1C is a left side view of the adjustable speed drive of FIG. 1A.

FIG. 1D is a right side view of the adjustable speed drive of FIG. 1A.

FIG. 2A is a top view of a conventional heat sink of the adjustable speed drive of FIGS. 1A-1D.

FIG. 2B is a front view of the heat sink of FIG. 2A.

FIG. 2C is an isometric view of the heat sink of FIG. 2B.

FIG. 3A is an isometric view of a heat sink that includes a plurality of notches according to one aspect of the present disclosure.

FIG. 3B is a top view of the heat sink of FIG. 3A.

FIG. 3C is a right side elevation view of the heat sink of FIG. 3B.

FIG. 3D is a front elevation view of the heat sink of FIG. 3B.

FIG. 4A is an isometric view of a heat sink that includes a scalloped surface according to one aspect of the present disclosure.

FIG. 4B is a top view of the heat sink of FIG. 4A.

FIG. 4C is a right side elevation view of the heat sink of FIG. 4B.

FIG. 4D is a front elevation view of the heat sink of FIG. 4B.

FIG. 5A is an isometric view of a heat sink that includes a scalloped surface according to one aspect of the present disclosure.

FIG. 5B is a top view of the heat sink of FIG. 5A.

FIG. 5C is a right side elevation view of the heat sink of FIG. 5B.

FIG. 5D is a front elevation view of the heat sink of FIG. 5B.

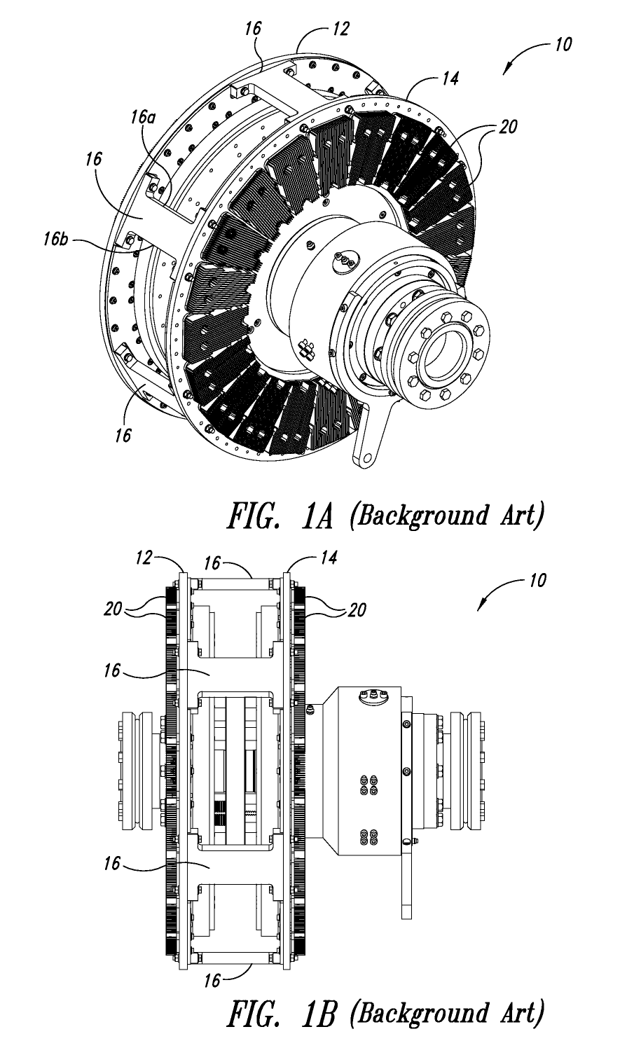

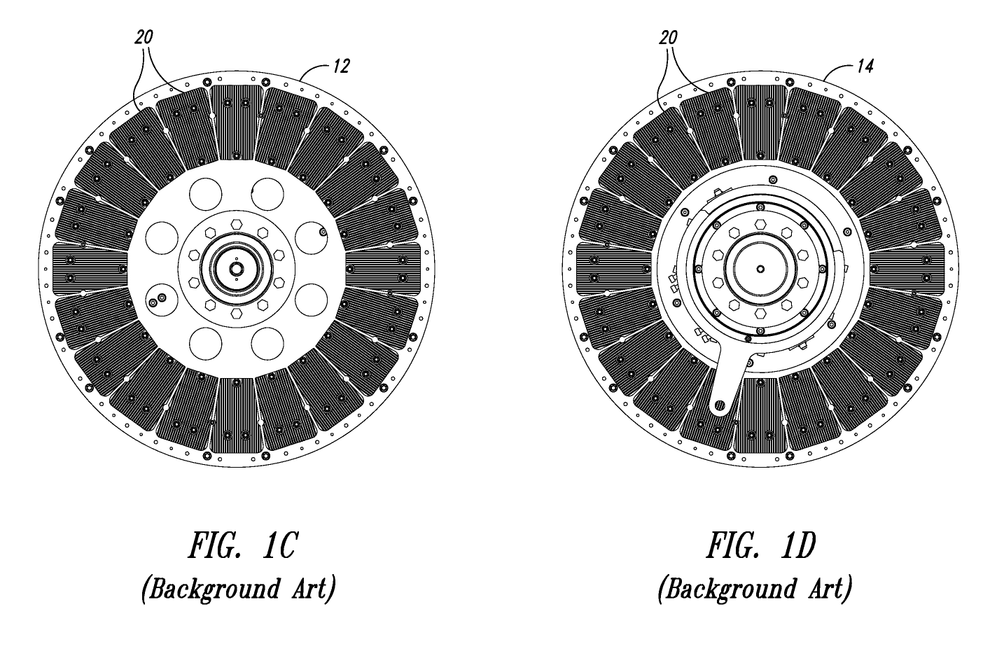

### DETAILED DESCRIPTION

In the following description, certain specific details are set forth in order to provide a thorough understanding of various embodiments of the invention. However, one skilled in the art will understand that the invention may be practiced without these details.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The Abstract of the Disclosure provided herein is for convenience only and does not interpret the scope or meaning of the embodiments.

As noted above, it has been recognized that heat sinks on adjustable speed drives can create an undesirably loud whistling noise above a threshold rotational speed of the adjustable speed drive. As shown in Table 1, below, it has been determined that it is possible to reduce sound levels to acceptable ranges for high speed operation while still maintaining the heat transfer benefits of the heat sinks by disrupting the edge geometry on fins of the heat sinks.

TABLE 1

| | Delta T/Slip [Deg F/HP] | | Sound Pressure | |
|---|---|---|---|---|
| | avg of 3 hottest spots, center | | Level [dB(A)], | |
| All tests are at 1800 RPM, locked rotor at | of cond @ mag centerline | | 8 position avg | |
| approximate air gap of 1.87″ | Motor Side | Load side | At 1 meter | At 3 Meter |
| Standard Full Height Heat Sinks: | | | | |
| Test 52, Standard unit, no NRE | 4.5 | 6.0 | 108.2 | 103.5 |
| Test 53, Standard unit, standard NRE, | 4.6 | 6.1 | 92.5 | 88.8 |
| standard muffler | | | | |
| Test 54, Standard unit, standard NRE + | 4.4 | 5.5 | 93.7 | 90.0 |
| low restriction muffler | | | | |
| “Scalloped” heat sinks | | | | |
| Test 59/60, “7 scallop” heat sinks, with | 4.5 | 5.7 | 94.2 | 90.3 |
| Open/flared NRE + low restriction muffler | | | | |
| “Notched” (and scalloped) heat sinks | | | | |
| Test 62, Notched, no NRE | 4.6 | 5.8 | 96.2 | 92.0 |
| Test 63, Notched, with standard NRE with | 4.4 | 5.3 | 93.3 | 89.4 |
| low restriction muffler | | | | |
| Test 64, Notched, with standard NRE, | 4.7 | 5.8 | 90.6 | 86.8 |
| standard muffler | | | | |
| Test 66, Notched, with open/flared NRE + | 4.5 | 5.6 | 93.4 | 89.2 |
| low restriction muffler | | | | |
| “Slotted” Heat Sinks | | | | |
| Test 46/47, 5 Slot Heat Sinks, no NRE | 4.7 | 5.8 | 97.0 | 92.2 |
| Test 51, 5 slot heat sinks, with “bell mouth” | 4.3 | 5.5 | 99.9 | 96.2 |
| NRE, low restriction muffler | | | | |
| “Notched” heat sinks, tops & ends | | | | |
| Test 68, Notched, no NRE | 4.7 | 5.9 | 96.6 | 91.8 |
| Test 69, Notched, with standard NRE, | 4.9 | 5.8 | 90.6 | 86.6 |
| standard muffler | | | | |
| Test 70, Notched, with standared NRE, low | 4.8 | 5.4 | 92.4 | 89.8 |
| restriction muffler | | | | |

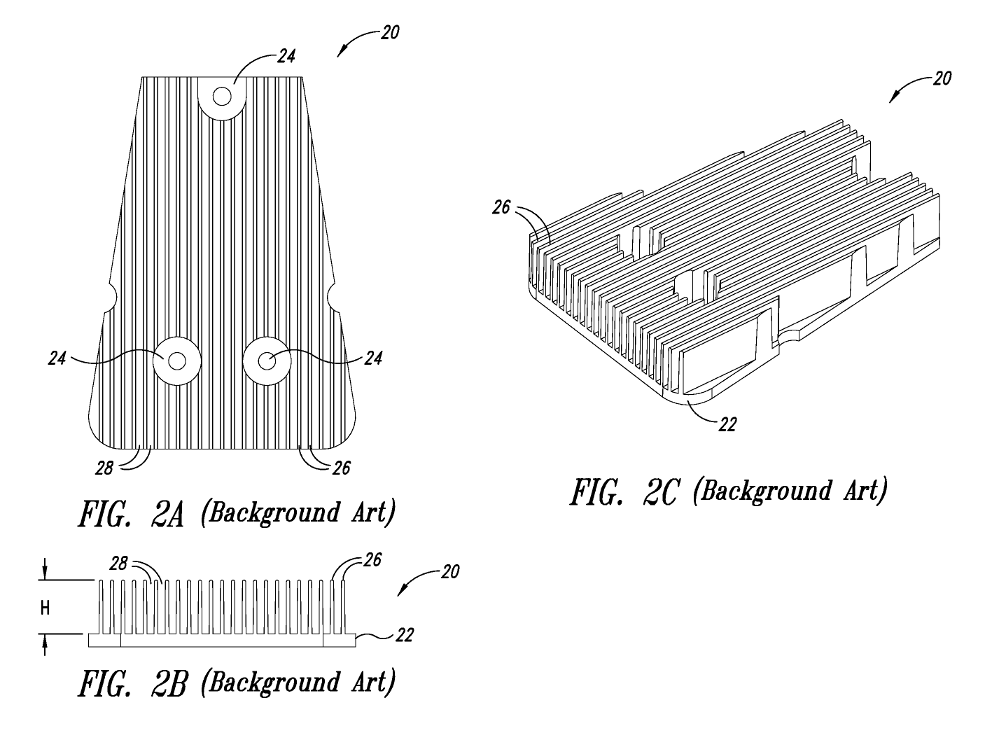

As shown in table 1, an adjustable speed drive operated at 1800 RPM, a relatively high speed, with a conventional heat sink, such as the heat sink illustrated in FIGS. 2A-2C, generates noise at levels of 108.2 dB(A) at 1 meter, and 103.5 dB(A) at 3 meters. Adding a noise reduction enclosure (NRE) to the adjustable speed drive reduces the noise generation to 92.5 dB at 1 meter and 88.8 dB(A) at 3 meters.

As is described in U.S. Provisional Patent Application No. 61/770,003, titled “Apparatus, Systems And Methods For Reducing Noise Generated By Rotating Couplings,” the entire contents of which are incorporated herein by reference, it has been further observed that: (1) by reducing the fin height on the heat sinks, sound levels can be reduced to acceptable ranges for lower speed operation of the adjustable speed drive; and (2) including slots across the fins and heat sink elements also has a favorable effect on sound level reduction, including at high speeds of operation.

Noise reduction due to the inclusion of slots is reflected in Table 1. For example, a full-height heat sink that includes five full-height slots showed a noise level of 97.0 dB(A) at 1 meter and 92.2 dB(A) at 3 meters when running an adjustable speed drive at 1800 RPM without a noise reduction enclosure. A noise reduction in more than 10 dB(A) represents a significant drop in noise generation.

However, unexpectedly, this slotted heat sink configuration resulted in an increase in the amount of noise generated when a noise reduction enclosure was added to the adjustable speed drive—99.9 dB(A) at 1 meter and 96.2 dB(A) at 3 meters. With the noise reduction enclosure in place, the noise level not only increase, but a whistle associated with a resonance frequency was audible.

It was observed that the deficiencies in the slotted configuration can be overcome by disrupting the edge geometry on fins of the heat sinks without generating full-height slots. For example, as shown in Table 1, above, a notched heat sink showed a noise level of 96.6 dB(A) at 1 meter and 91.8 dB(A) at 3 meters when running an adjustable speed drive at 1800 RPM without a noise reduction enclosure. When the adjustable speed drive is run with an noise reduction enclosure, the noise level even went down further to 90.6 dB(A) at 1 meter and 86.6 dB(A) at 3 meters. As such, the notched heat sink configuration results in reductions in noise generation both with and without a noise reduction enclosure.

Notably, the notched heat sink demonstrated similar heat dissipation performance when compared to the standard, non-modified heat sink. As such, there is no heat penalty to altering the heat sink in a manner that reduces the noise creation.

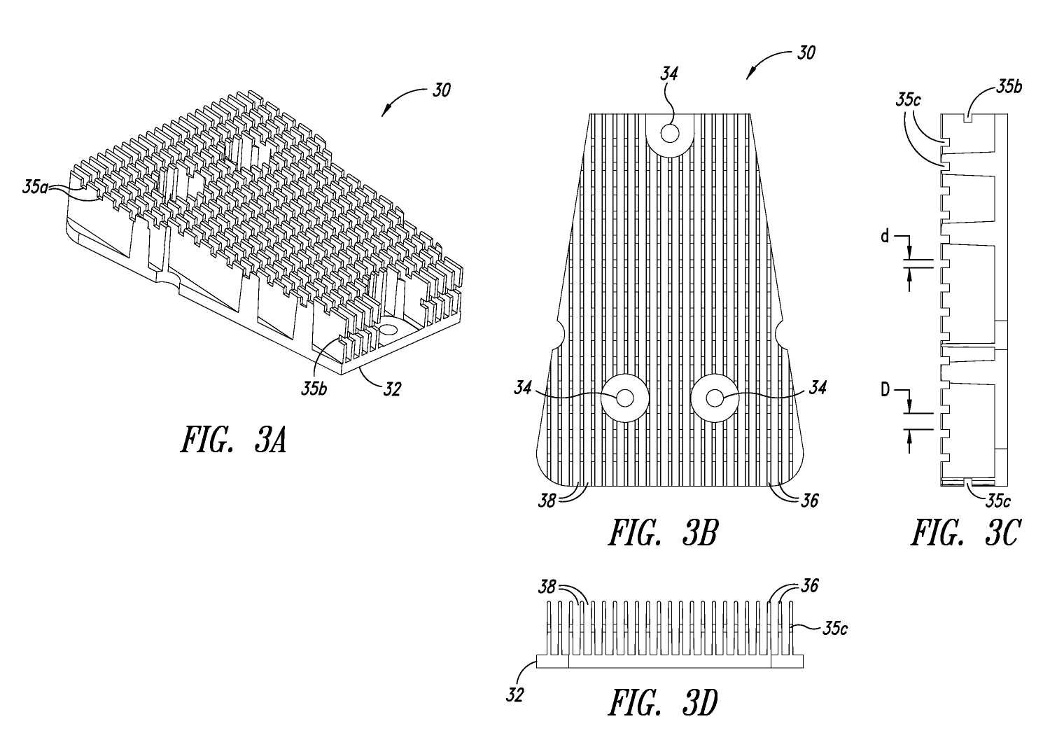

FIGS. 3A-3D illustrate a notched heat sink element 30 according to one example of the present disclosure. The heat sink element 30 includes a base 32 from which extend a plurality of fins 36. The fins 36 define channels 38 therebetween and extend above the base 32. The fins 36 further include a plurality of notches. Several rows of notches 35a extend substantially transverse to the direction of extension of the fins 36, thereby disrupting a top surface of the fins. In this example, notches 35b interrupt a front surface of the fins 36, and notches 35c interrupt a rear surface of the fins 36. In this example, the notches are rectangular with a width d and a depth in a range of about 0.02 inch to 0.80 inch. In other examples, the notches can be triangular, circular, or other known polygonal or irregular shape, or any combination thereof. The notches can be spaced at regular or irregular intervals. In some examples, the notches are spaced apart a spacing D in a range of about 0.02 inches to about 1.0 inches. Unlike the slotted configurations disclosed in U.S. Provisional Patent Application No. 61/770,003, the notches of the present disclosure are surface disruptions that do not extend the full height of the fins 36. The heat transfer elements 30 can be affixed to conductor rotors via mounting holes 34.

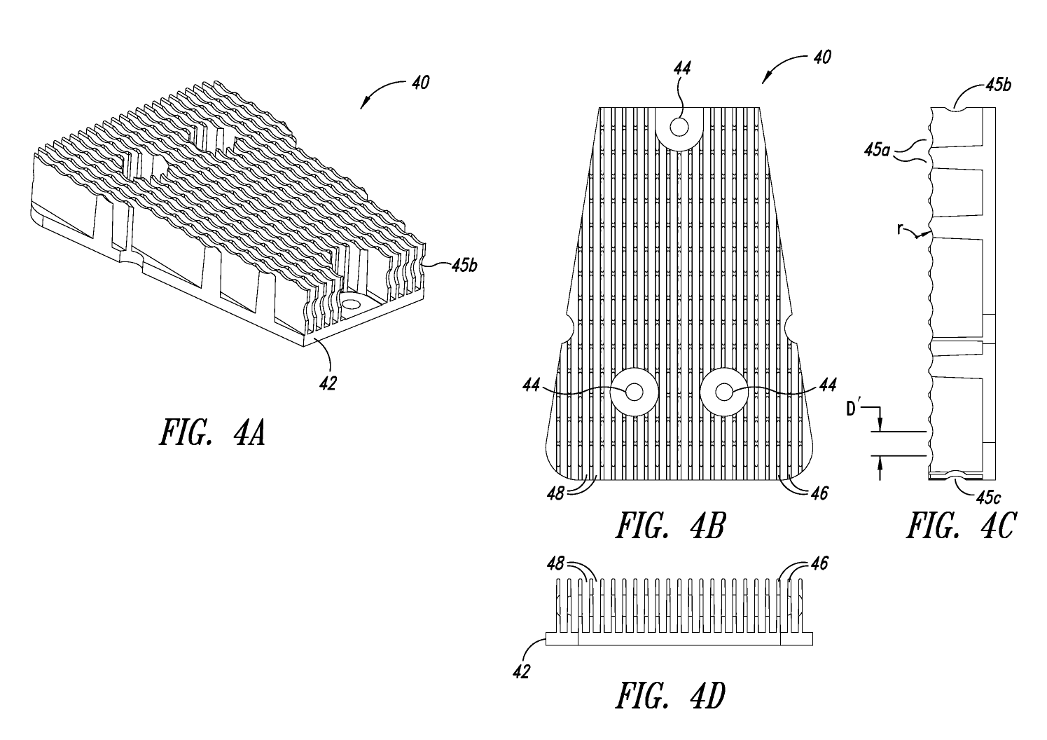

FIGS. 4A-4D illustrates another example in which the exposed surfaces of the fins of a heat sink are disrupted with a scalloped profile. The heat sink element 40 includes a base 42 from which extend a plurality of fins 46. The fins 46 define channels 48 therebetween and extend above the base 42. The fins 46 further include a plurality of scallops. Several rows of scallops 45a extend substantially transverse to the direction of extension of the fins 46, thereby disrupting a top surface of the fins. In this example, scallops 45b interrupt a front surface of the fins 46, and scallops 45c interrupt a rear surface of the fins 46. In this example, the scallops are defined by a radius r and are separated by a distance D′. As with the previous example, the disruptions can be spaced at regular or irregular intervals. In some examples, the disruptions are spaced apart a spacing D′ in a range of about 0.02 inches to about 1.0 inches. The heat transfer elements 40 can be affixed to conductor rotors via mounting holes 44.

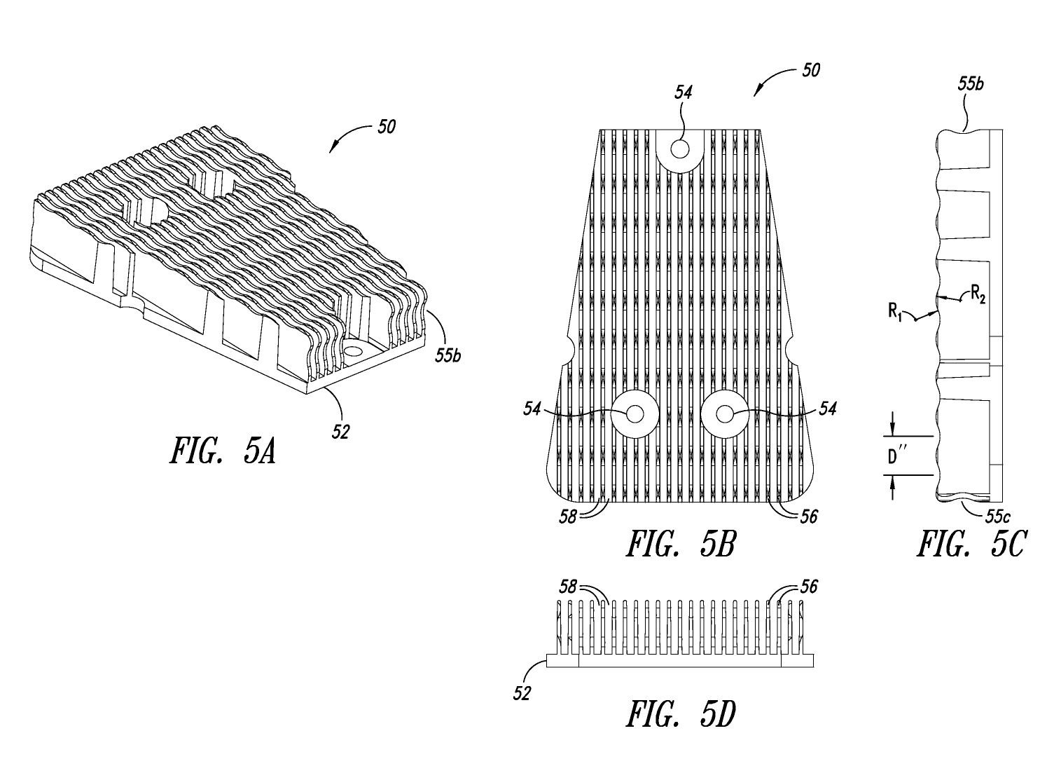

FIGS. 5A-5D illustrates another example in which the exposed surfaces of the fins of a heat sink are disrupted with a continuous curve. The heat sink element 50 includes a base 52 from which extend a plurality of fins 56. The fins 56 define channels 58 there between and extend above the base 52. The fins 56 further include a continuous curve defined by the radii R₁ and R₂, with a minimum fin heights separated by a distance D″, thereby disrupting a top surface of the fins. In this example, the curve extends along a front surface of the fins 56 at 55b, and along a rear surface of the fins 56 at 55c. In this example, the scallops are defined by a radius r and are separated by a distance D′. The heat transfer elements 50 can be affixed to conductor rotors via mounting holes 54.

It is further noted that, in some examples, the disruptions can be offset from each other on adjacent fins, such that the disruptions are discontinuous with respect to each other when viewed in a circumferential direction of the heat sink member.

In addition to new installations, noise improvements can be achieved by replacing existing heat transfer elements with any of the improved heat transfer elements described herein. For example, full height heat transfer elements can be replaced with half-height heat transfer elements for low-speed applications. For higher speed applications, full height heat transfer elements can be replaced with slotted heat transfer elements, having the appropriate height necessary for the desired heat transfer.

Although specific reference is made to adjustable speed magnetic drive systems the heat sinks of the present disclosure can also be used in combination with other air cooled mechanisms, including, but not limited to, fixed gap magnetic couplings and magnetic couplings and drives that include speed trimming, torque limiting, and delayed start features.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A heat sink element for a device operable by relative rotation of a conductor rotor assembly and a magnet rotor assembly, the heat sink element comprising:
a base portion that includes a mounting face that is sized and dimensioned to be coupled to the conductor rotor assembly, and an opposing convective heat transfer face;
a plurality of fins extending from the convective heat transfer face of the base portion, adjacent fins separated by a channel that extends along a longitudinal direction of the fins, the fins including at least one surface disruption on a top surface thereof.

2. The heat sink element of claim 1, wherein the surface disruption is a notch.

3. The heat sink element of claim 1, wherein the surface disruption is a triangle.

4. The heat sink element of claim 1, wherein the surface disruption is a scalloped surface.

5. The heat sink element of claim 1, wherein the surface disruption is a continuous curve.

6. An rotary unit, comprising:
a magnet rotor assembly;
a conductor rotor assembly positioned relative to the magnet rotor assembly such that there is an air gap between the magnet rotor assembly and the conductor rotor assembly, and such that relative rotation of the conductor and magnet rotor assemblies induces a magnetic coupling across the air gap; and
a heat sink assembly coupled to the conductor assembly, the heat sink assembly including a plurality of fins, adjacent fins separated by a channel that extends along a longitudinal direction of the fins, the fins including at least one surface disruption on a top surface thereof.

7. The adjustable speed magnetic drive unit of claim 6, wherein the heat sink assembly includes a plurality of heat sink elements that are arranged on an external surface of the conductor rotor assembly, each heat sink element including the plurality of groupings of fins.

8. The adjustable speed magnetic drive unit of claim 7, wherein, on at least one of the heat sink assemblies, the surface disruption is a notch.

9. The adjustable speed magnetic drive unit of claim 7, wherein, on the at least one of the heat sink assemblies, the surface disruption is a triangle.

10. The adjustable speed magnetic drive unit of claim 7, wherein, on the at least one of the heat sink assemblies, the surface disruption is a scalloped surface.

11. The adjustable speed magnetic drive unit of claim 7, wherein, on the at least one of the heat sink assemblies, the surface disruption is a continuous curve.

12. A method of reducing noise generated by a rotary member that is operable by relative rotation of a conductor rotor assembly and a magnet rotor assembly, the method comprising:
removing a first heat sink element from the conductor rotor assembly, the first heat sink element including a first plurality of fins that extend in a substantially radial direction relative to an axis of rotation of the conductor rotor assembly; and then
coupling a second heat sink element to the conductor rotor assembly in place of the first heat sink element, the second heat sink element including a second plurality of fins that extend in a substantially radial direction relative to the axis of rotation of the conductor rotor assembly, the exposed surface area of the second plurality of fins including a surface disruption profile.

13. The method of claim 12, wherein the surface disruption profile includes a plurality of notches.

14. The method of claim 12, wherein the surface disruption profile includes a plurality of triangles.

15. The method of claim 12, wherein the surface disruption profile includes scalloping.

16. The method of claim 12, wherein the surface disruption profile includes a continuous curve.
